(19) United States
(12) Patent Application Publication
(10) Pub. No.: US 2022/0292614 A1
(43) Pub. Date: Sep. 15, 2022

(54) Law And Order Enforcement System Using A Social Network

(71) Applicant: JEAN EDRICE GEORGES, BOYNTON BEACH, FL (US)

(72) Inventor: JEAN EDRICE GEORGES, BOYNTON BEACH, FL (US)

(21) Appl. No.: 17/169,508

(22) Filed: Feb. 7, 2021

(51) Int. Cl. G06Q 50/00; G06V 20/54; G06V 20/40; H04N 7/18; H04N 5/76; G06V 20/58; G06T 7/292; G06Q 50/26

(52) U.S. Cl. CPC G06Q 50/01; G06V 20/54; G06V 20/40; H04N 7/18; H04N 5/76; G06V 20/58; G06T 7/292; G06Q 50/26; G06T 2207/30252; G06T 2207/10016; G06T 2207/30232

(57) ABSTRACT

A law and Order Enforcement System having comprising a video monitoring system made out of a social group of individuals with video cameras mounted either inside or outside of at least one vehicle, up to an unlimited number of vehicles, either moving or parking, for the purpose of capturing, collecting, recording video images and audio data, day and night, of surrounding areas, anywhere in a country, state, county, city, and zip code, and wherever vehicles are located, driven, stopped or parked, on and off the road, for use to monitor and enforce the law and order remotely, physically or a combination of both; said video and audio data recording may either be manually downloaded or directly stored into a cloud address to create a unique data base; wherein said data can be stored and preserved to create a unique portal for local law enforcements or other authorized users to access and investigate cases including, but not limited to, crimes, accidents, traffic violations, thefts, robberies, child abductions, missing persons or any other wrong doings that may occurred and related to public safety; wherein said data can also be accessed from anywhere in the country they might occur.

### CROSS REFERENCE TO RELATED APPLICATIONS

This application is also based on provisional application Ser. No. 62/971,911 filed on Feb. 7, 2020

### FIELD OF THE DISCLOSURE

The present invention relates generally to the field of public safety and security, more particularly to a social group of drivers having their cars being equipped with a video camera recording system, either built-in or dash-mounted, with engine running or off, being located in multiple regions or locations such as countries, states, counties and cities, and are designed to capture and record sound and video images of the street and their surrounding areas where they're located. Such recordings are therefore collected, downloaded, and stored in a unique cloud base network to then be used later by local state, city, and county law enforcement officials, when needed, for possible evidence related to certain unlawful cases. Such evidence may include, but not limited to, wrong doings, crimes, thefts, robberies, road rages, missing persons, expired tags, on the run criminals, traffic violations and car accidents.

### BACKGROUND OF THE INVENTION

If real-time data and alerts from all smart-city sensor comes directly to the nearest police officer, will he be able to make an informed decision? I don't know about you, but I'm one of those drivers who wished that a law enforcement officer was around the corner when another driver acted stupidly while at the same time putting other drivers' life in danger. It's almost impossible for law enforcement and security personnel around the country to be present at the right place and at the right time while a wrongdoing is taking place. What is needed are policing strategies to meet the challenges of evolving technology and a changing world. People get shot every day, even in plain daylight sometimes, and still there is little or no evidence as who the perpetrator(s) is or are. Despite the video revolution, a lot of these law breakers are barely got caught because spotty videos and poor screen shots taken from distant front home video cameras aren't sufficient. Most front screenshot video camera mostly show the car's side and its color but unable to show the tag number. Meanwhile, insurance companies as well as consumers spend millions of dollars each year on accident claims and high insurance premiums without certain whose drivers really at fault since there is not enough evidence to prove the contrary. Some street corners may have some type of video recording, but anything can happen in any corner, any street, anywhere. Sometimes, perpetrators got caught in action, thanks to smartphone videos taken by bystanders. Because of such a lack of witnesses or proof of evidence in the current system, there is a need for a better video recording system that can provide recorded live evidence during, before or after a scenario with no need for a single person or eyewitness. When used with Artificial Intelligence, Data mining and Data analytics are very powerful when it comes to catching anomalies or similarities. City and county enforcement can use this new system to issue traffic violations despite no police was present. Missing persons will be easier to track since some drivers may have filmed something, someone, somewhere down the street around the city or county, and sometime in morning, afternoon, or at night. Criminals will be easier to track regardless whether they drove or walk to commit their crime because chances are some drivers may have been there, filming, before or while they were about to leave to commit the crime, and all the way to the crime scene. Furthermore, a route can well be retraced back from the end point, all the way to the starting point and vice versa. All is needed is at least one car with a camera on each driven street. With this new system, the possibility is endless.

Also, traffic violations video recording is also meant to encourage drivers to drive safer and better by including a phase 1 period; during such a period, drivers in violations may receive warning tickets as to have them on notice and also encourage them to do the right things while driving. In the end, knowing the big dude is watching, people will drive safer better which will result in fewer accidents and death related crashes.

### SUMMARY OF THE INVENTION

In accordance with an embodiment of the present invention, it is contemplated that a Dash Cam Video recording Network made of a social network of drivers, with cars with video cameras, built-in or mounted anywhere inside multiple vehicles to collect or record video images, day and night, from anywhere in a country and where ever they may be located, driven, stopped or parked. Said video images may either be manually downloaded or directly recorded into a cloud based address to create a unique data base; wherein said data can be stored and preserved to create a unique portal for the purpose of investigating crimes, accidents, traffic violations, thefts, robberies, missing persons, or any wrong doings that took place in the open, and related to public safety; wherein said data can also be accessed from anywhere, where ever in the country they might occurred. Said central video collection system for vehicles with GPS' capable video cameras, and also having a countless number of vehicle with camera recordings in every city, every street, every turn, every angle, and every second, has the capability of tracking back a vehicle, a driver or a person from an end point, all the way to the point of origin. Said central video collection system for vehicles with video cameras also is supported with backup portable batteries to guaranty nighttime and longer hours recordings without relying on vehicles' own power supply when parked.

The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiment of the invention are illustrated.

### BRIEF DESCRIPTION OF THE DRAWINGS

The invention and its various embodiment are more fully appreciated in connection with the following detailed description taken in conjunction with the accompanying drawings, in which:

FIG. 1 is a picture of a camera with mounting features.

FIG. 2 is a picture of a portable battery supply to power an electronic device.

FIG. 3 depicts a car parked on a driveway facing the street, having a camera installed over the dash or under the windshield.

FIG. 4 shows a car parked on a driveway at nighttime facing the street, having a camera installed over the dashboard or under the windshield.

FIG. 5 shows a car facing away from the street, having a camera installed on the rear end or under the rear windshield.

FIG. 6 is a view of city traffics showing a network of cars on the road recording and saving data from various sources to be sent to the cloud, which could be available for search in the future or when needed.

FIG. 7 illustrates areas where this system will likely help improving.

FIG. 8 is a view that demonstrates possible end users of the new system.

FIG. 9 illustrates a scenario where a vehicle's previous route can be traced backward and/or forward.

FIG. 10 shows a more detailed scenario on how the back-tracking system works, with the shooter in his car.

FIG. 11 shows a traffic scene where two police cars parked on both side of the street and opposite to each other.

FIG. 12 shows a police command center.

FIG. 12A shows a car with a highlighted license plate while another car is driving behind it.

FIG. 12B shows a police car and a laptop computer with written information on the screen.

### DETAILED DESCRIPTION OF THE PREFERRED EMBODIMENTS

A detailed description of one or more embodiments is provided below along with accompanying figures that illustrate the principles of the embodiments. The scope of the embodiments is limited only by the claims and encompasses numerous alternatives, modifications, and equivalents. Numerous specific details are set forth in the following description. These details are provided solely for the purposes of example and the embodiments may be practiced according to the claims without some or all these specific details.

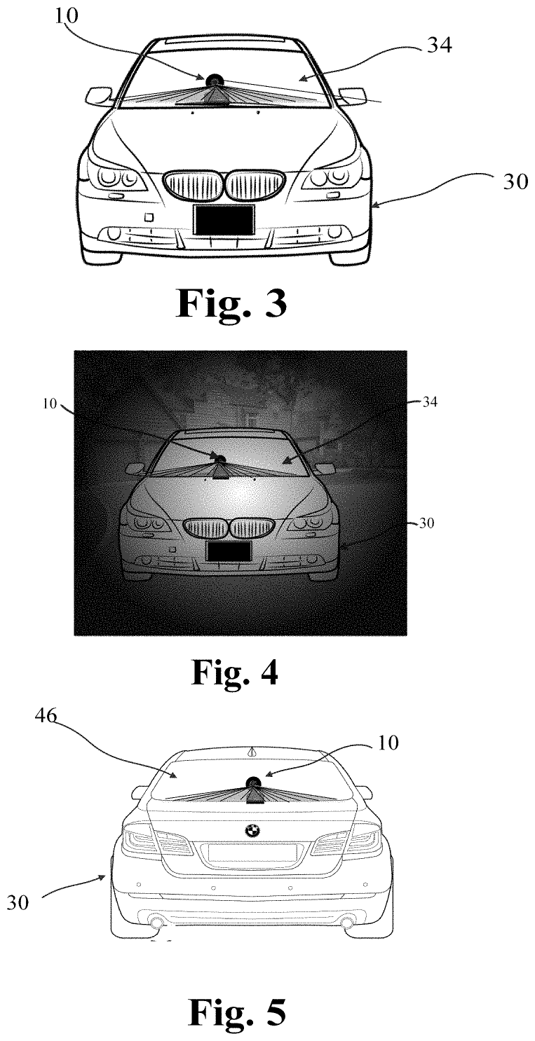

Referring to the drawings in FIG. 1, camera 10 is shown with suction cup 12 to securely adapt over dashboard u or under rear windshields respectively 34 and 46, as shown in FIGS. 3 and 4.

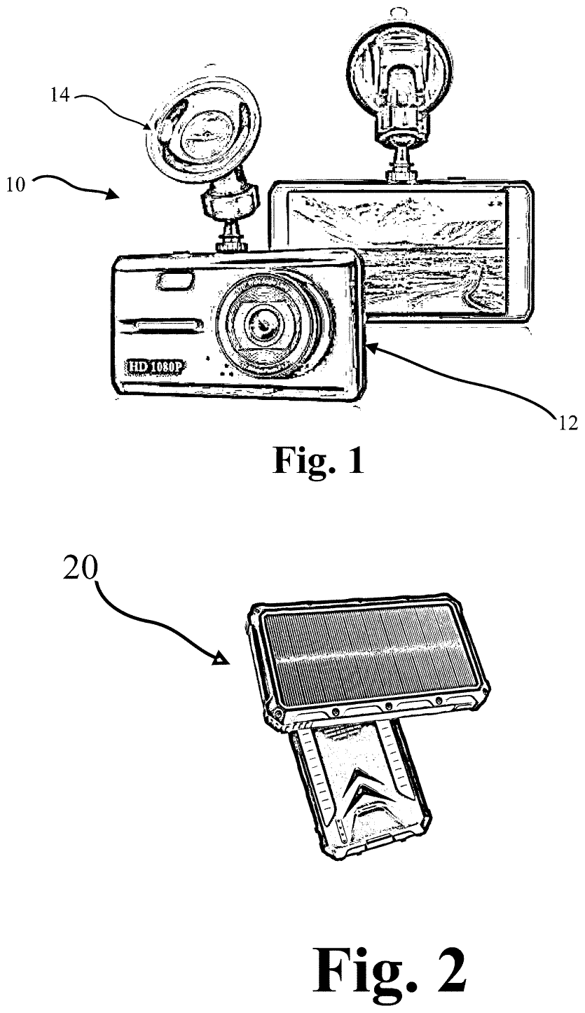

Referring to FIG. 2, battery 20 is used to provide power when vehicle 30 is either parked or engine not running.

Referring to the drawings, vehicle 30 in FIG. 3 is parked, facing the street, having camera 10 mounted over the dashboard or under the front windshield 34.

Referring to FIG. 4, vehicle 30 is parked during nighttime, having camera 10 powered with battery 20 (not shown).

Referring to FIG. 5, vehicle 30 is parked with rear facing the street, having camera 10 mounted under its front windshield 34 or over its rear board (not shown).

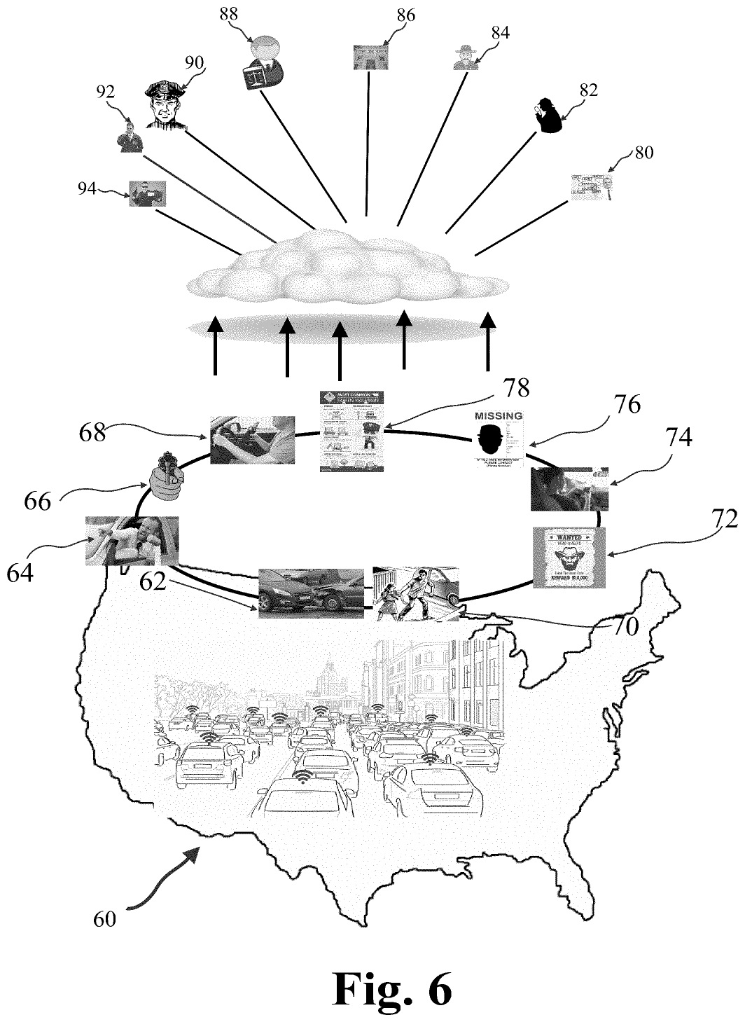

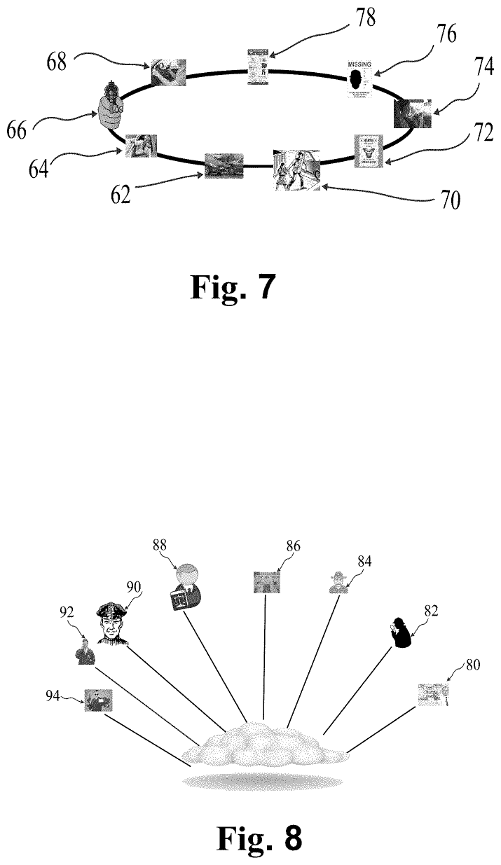

Referring to FIG. 6, a map 60 representing a country, more specifically the United States, having camera 10 used on multiple vehicles 30 to record or collect data while driving, capture possible events including, but not limited to, vehicle accidents 62, road rage 64, crime 66, drinking and driving 68, abduction 70, most wanted 72, reckless driving 74, missing persons 76, and traffic violations 78, to then be sent and saved in the cloud, as shown in FIG. 7. These data are automatically been categorized primarily by country or state, then county, city, and zip code to facilitate a search. From there, they can be used by many authorized end users including, but not limited to, auto insurance companies 80 (proof of who's at fault), investigators 82, county sheriff 84, traffic court 86, lawyers 88, city police 90, FBI 92 and CIA 94, as shown in FIG. 8.

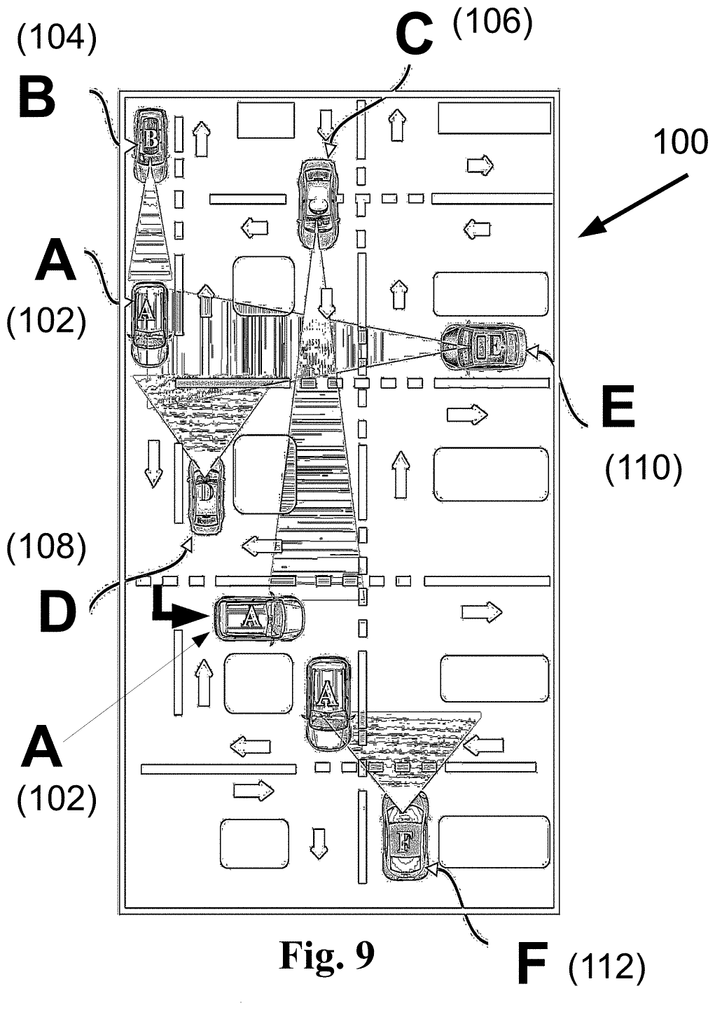

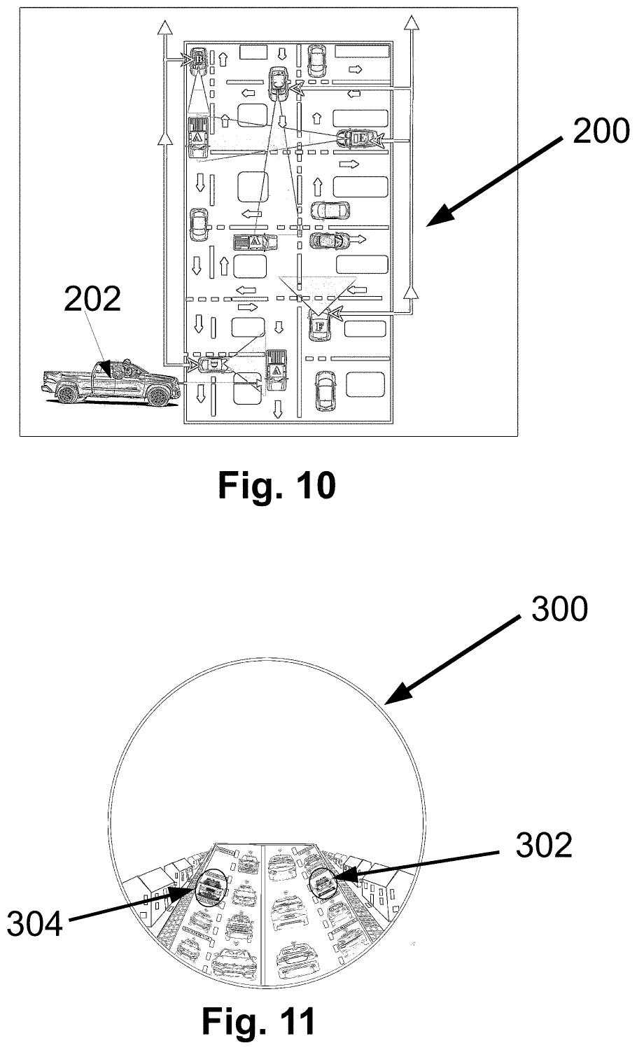

Referring to FIGS. 9 and 10, with the help of Artificial Intelligence(AI), the system is able to back track and/or forward track the shooter's vehicle (A) to find out where the trip started, providing there was at least one (parked or moving) dash cam vehicle in the network (B, C, D, E, F) or one doorbell camera (not shown), in the surrounding area the target vehicle (A) has been driven. This event describes the targeted vehicle being captured by multiple dash cams. Target vehicle A (southbound) has been captured by dash cams 104 and 110, southbound—westbound respectively, describing the license plate number, a key piece of evidence; target vehicle A (eastbound) also captured by dash cams 106 (southbound); target vehicle A (southbound) captured by dash cam 112 (northbound). Dash cams 106 and 110 capture the driver's side while dash cams 108 and 112 provide a closer look of the front windshield or the driver.

Referring to FIG. 11, two dispatched police cars 302 and 304 are both parked on the opposite side and direction of the street while waiting on possible traffic alerts from the dash cam network. Instead of driving down the streets looking to enforce traffic rules on unlucky drivers, these outnumbered police officers sometimes need to be on standby while waiting for the network to find them those drivers through data migration from.

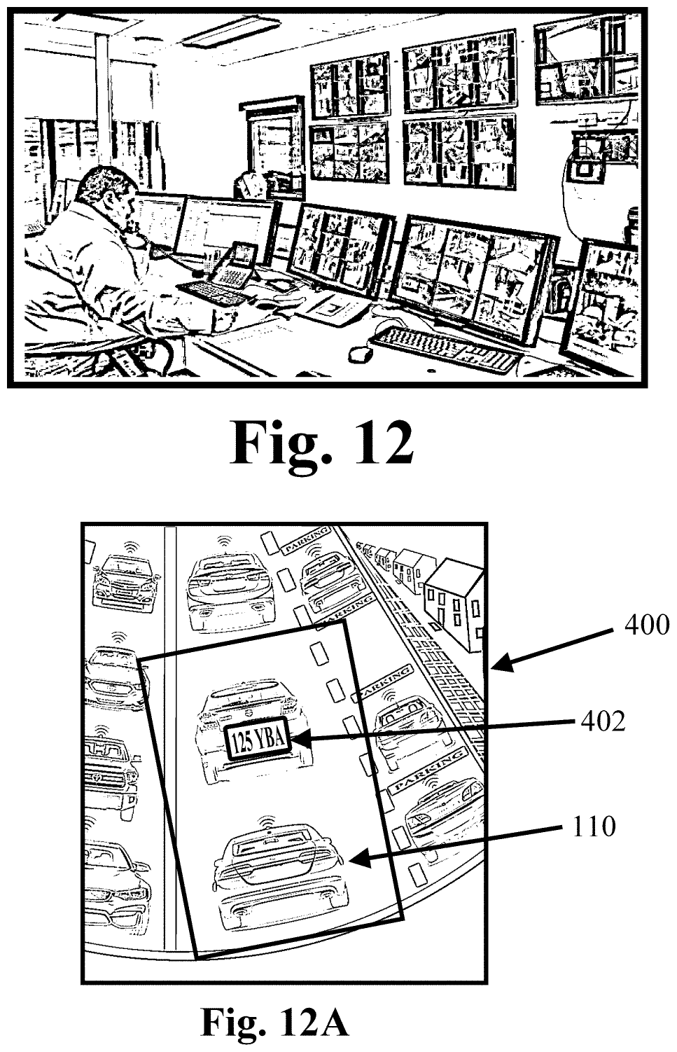

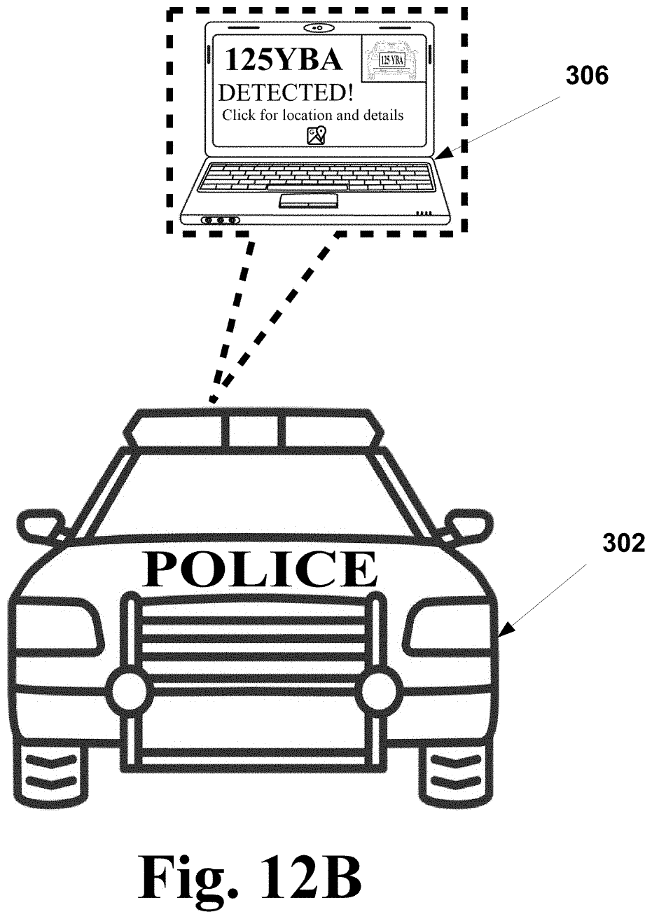

Referring to FIG. 12, Florida authorities send an amber alert about a Florida license 125 YBA regarding an abducted 4-year-old child. The amber alert was sent to the dash cam network with multiple drivers with dash cams driving the streets or parking on driveways day and night.

Referring to FIG. 12A, a driver with a dash cam 110 on his way to work, happened to drive behind a car with plate number 125YBA when Artificial Intelligence (AI) captured the information, all without the knowledge of the driver himself. Such data was then sent to the nearest dispatch vehicle, including map with location.

Referring to FIG. 12B, a police vehicle 302 parked on the side of the street while receiving an alert on his laptop 303 from the dash cam network about the location of a kidnaping 4-year old child (not shown). The officer follows the instruction on the screen which will take him to the target vehicle 402. From that point on, the target vehicle itself, with plate number 125YBA becomes the destination point of the police vehicle, regardless of the route taking.

What is claimed:

1. A video monitoring system made out of a social group of individuals with video cameras mounted either inside or outside of at least one vehicle, up to an unlimited number of vehicles, either moving or parking, for the purpose of capturing, collecting, recording video images and audio data, day and night, of surrounding areas, anywhere in a country, state, county, city, and zip code, and wherever vehicles are located, driven, stopped or parked, on and off the road, for use to monitor and enforce the law and order remotely, physically or a combination of both; said video and audio data recording may either be manually downloaded or directly stored into a cloud address to create a unique data base; wherein said data can be stored and preserved to create a unique portal for local law enforcements or other authorized users to access and investigate cases including, but not limited to, crimes, accidents, traffic violations, thefts, robberies, child abductions, missing persons or any other wrong doings that may occurred and related to public safety; wherein said data can also be accessed from anywhere in the country they might occur.

2. A video monitoring data network system for vehicles with video cameras that offers flexibility in law and order for federal, states and local law enforcement while facing long term challenges of population grow in the years to come.

3. A video monitoring data network system for vehicles with video cameras having a GPS capability, being installed anywhere in the inside and/or the outside of at least 1 vehicle, up to an unlimited number of vehicles, capable of recording data in every city, every street, every corner and turn, practically every second, and has the capability of tracking a vehicle or a driver, turn by turn, from destination down to the point of origin.

4. The system in claims 1 and 2 wherein a video monitoring data network made out of a social group of individuals that can be used in conjunction with an existing amber alert system to track kidnappers, criminals, child abduction cases, where a license plate number can be easily captured by said network while sending the information directly to a law enforcement nearby, all with no phone call or any specific action from a driver.

5. The system in claim 1 wherein a central video collection system for vehicles with video cameras having a Hot-Spot capability, being installed anywhere in the inside and/or the outside of at least 1 vehicle, up to an unlimited number of vehicles, capable of connecting with cell phone hot spot, for the purpose of transmitting live data to said central video collection system.

6. The system in claim 1, wherein local police and county sheriff are being dispatched into zones instead of driving throughout the city or county, waiting for signals from drivers within the network.

1. The system in claim one wherein said data collected may target drivers who are driving with a suspended license, through their license plate, using Artificial Intelligence (AI).

2. The system in claim 1 wherein said data collected may be sent to the nearest law enforcement officer in the area for a same day citation issuance, identifying location and plate number of said vehicle whom driver is suspended.

3. The system in claim one wherein said captured data showing a driver committing any non-crash traffic violation may also be automatically sent to the nearest police officer in the area for citation.

4. The system in claim one wherein said captured data may be sent to a central data collection unit for processing in the event no law enforcement officer was present in the near vicinity where the violation did occur, as in the case of a red light camera violation.

5. The system in claim one wherein, with the help of Artificial Intelligence (AI), a collision or a traffic accident can be automatically detected and reported simultaneously to both the nearest law enforcement officer and the 911 information system with location information, images and a glimpse of the state of the accident just minutes after such accident took place, all without the need to call 911 as it's usually the case.

6. The system in claim 1 wherein said captured crash data may be downloaded and saved in a cloud data base, and can be used later by authorized private and public investigators, insurance companies and the court system to further determine which driver was at fault at the time of the accident.

7. The system in claim one wherein captured video data may be used to locate and track criminals, robbers, thieves, kidnappers, child abduction, and others.

8. The system in claim one wherein once a case has been identified and targeted by the network, thanks to AI, with no knowledge of said targeted driver, said vehicle would be tracked and became an ultimate destination point for law enforcement pursuing said target vehicle until apprehended, therefore reducing car chasing fatality.

9. The system in claim 1 wherein said captured video data can help determine where a criminal, robber, thief, kidnapper, and others came from, using Artificial Intelligence to back tracking possible videos recorded from parked or moving vehicles within the network, that was in his or her path, turn by turn.

10. The system in claim 1 wherein said captured video data can help determine, using Artificial Intelligence, where a criminal went from the crime scene by forward tracking possible videos recorded from parked or moving vehicles within the network, and also were in his or her path, turn by turn.

11. The system in claim one wherein said traffic violations video recording is also meant to encourage drivers to drive safer and better by including a phase 1 period; during such a period, drivers in violations may receive warning tickets as to have them on notice.

12. The system in claim one wherein said central video collection system can keep a record of streets being driven using GPS technology, to help facilitate the search in the system.

13. The system in claim 2 wherein said dash cam is also supported with portable batteries to guaranty nighttime and longer hours recordings without relying on vehicles' own power supply when parked.
